(19) United States
(12) Patent Application Publication
(10) Pub. No.: US 2008/0154768 A1
(43) Pub. Date: Jun. 26, 2008

(54) Automated appraisal fee processing software for real estate transactions

(75) Inventor: Stacey Caron, Orange, CA (US)

Correspondence Address: ZUBER & TAILLIEU LLP, 10866 WILSHIRE BLVD., SUITE 300, LOS ANGELES, CA, 90024, US

(73) Assignee: APPRAISAL FEE SERVICES, INC.

(21) Appl. No.: 11/580,249

(22) Filed: Oct. 12, 2006

(51) Int. Cl. G06Q 20/00

(52) U.S. Cl. 705/40

(57) ABSTRACT

Software for use in securing payment of an appraisal fee in a real estate transaction wherein the software receives initial input requesting that a pre-authorization for the appraisal fee be obtained, obtains a pre-authorization for payment, receives final input once the appraisal has been completed, and ensures payment to the appraiser upon receipt of such final input. The software ensures that a borrower is aware of all payment and cancellation terms by notifying the borrower of such terms the moment a pre-authorization is requested—thereby reducing the risk of a reluctant or non-serious borrower. The software further ensures that an appraiser is paid once the appraisal is complete—facilitating timely appraisal completion.

### FIELD OF THE INVENTION

The invention relates to the field of real estate transactions. More specifically, the invention relates to an automated process for securing/authorizing, verifying, and completing an appraisal transaction in the real estate market.

### BACKGROUND OF THE INVENTION

In today's highly competitive real estate market, closing the deal is more important than ever and providing enhanced, innovative services that can help to expedite the process and ensure accuracy and completeness is crucial to success in the real estate market.

A key step in the process of purchasing or refinancing real estate is the borrower's obligation to obtain an appraisal in order to secure funding (a loan). In a typical environment, a lender will engage an appraiser on behalf of the borrower under COD (cash on delivery) payment terms. The appraiser will then inspect the property and provide/deliver a written appraisal to the lender. In this situation, the appraiser is then paid directly by the borrower for whom they were engaged.

One problematic issue which often arises is the reluctant or non-serious borrower may attempt to back out of or re-negotiate the deal before the appraisal is final and lending is secured. Another down-fall is that after the appraisal is complete, the value of the property might not meet lending requirements for a particular product/loan, resulting in a declined loan. In this situation, the would-be borrower often refuses to pay the final appraisal fee even though an appraisal has been completed and the appraiser needs to be paid. In these scenarios, the lender and/or the appraiser are left “holding the bag” for unpaid services.

Accordingly, what is needed is a system which ensures that a borrower is made aware of all appraisal payment and cancellation terms before any appraisal is rendered. What is further needed is a system which ensures that the appraiser will be fully paid upon completion of an appraisal. Finally, what is needed is an overall system which reduces the risk of a reluctant or non-serious borrower.

### SUMMARY OF THE INVENTION

The invention is for a software package which obtains a pre-authorization for appraisal payment, receives input once the appraisal has been completed, and ensures payment to the appraiser upon receipt of such input. The software ensures that a borrower is aware of all payment and cancellation terms by notifying the borrower of such terms the moment a pre-authorization is requested—thereby reducing the risk of a reluctant or non-serious borrower. The software further ensures that an appraiser is paid in full once the appraisal is complete—facilitating timely appraisal completion.

### DESCRIPTION OF THE DRAWINGS

FIG. 1 illustrates a system diagram in which the software of the present invention is preferably implemented/used; and

FIGS. 2a and 2b illustrate flowcharts for the preferred operations of the software of the present invention.

### DETAILED DESCRIPTION OF PREFERRED EMBODIMENTS

The invention is for a software package which obtains a pre-authorization for payment of an appraisal in a real estate transaction, receives input once the appraisal has been completed, and ensures payment to the appraiser upon receipt of such input by managing and controlling the amount paid by the borrower. The software ensures that a borrower is aware of all payment and cancellation terms by notifying the borrower of such terms the moment a pre-authorization is requested—thereby reducing the risk of a reluctant or non-serious borrower.

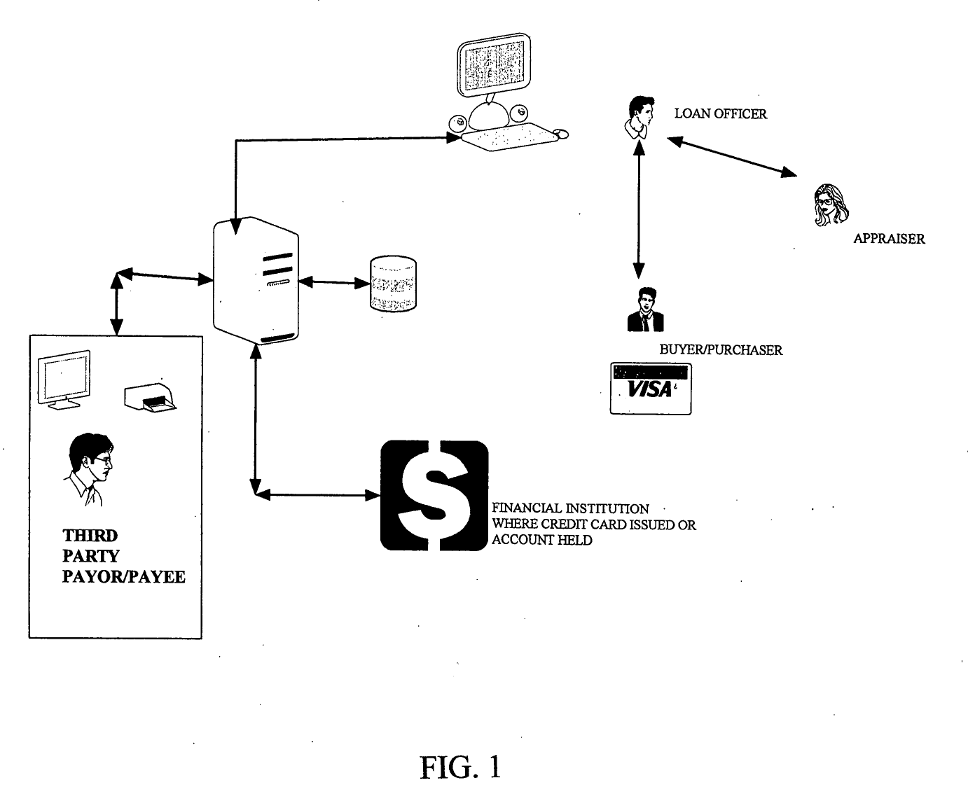

FIG. 1 illustrates a system diagram in which the software of the present invention is preferably implemented/used. As shown in FIG. 1, in a preferred embodiment the software of the present invention is implemented for use in a real estate transaction involving an Authorization Agent (typically a loan officer), a borrower, a Settlement Agent (typically a loan processor), and an appraiser. The software is hosted on a remote server at a third party payor/payee location and accessed by users via the Internet.

In a preferred embodiment, the Authorization Agent will log into the remote server where the software of the present invention is hosted (preferably via the Internet), and utilize the software in order to complete a pre-authorization transaction for future payment of an appraisal fee. Once the pre-authorization transaction is complete the agent can facilitate an appraisal order on behalf of the borrower—i.e the agent retains the services of an appraiser on behalf of the borrower. After the appraisal is complete, and the appraiser has provided a full appraisal report to the loan officer/agent, the software of the present invention is used to complete the transaction and facilitate complete payment of the appraisal fee.

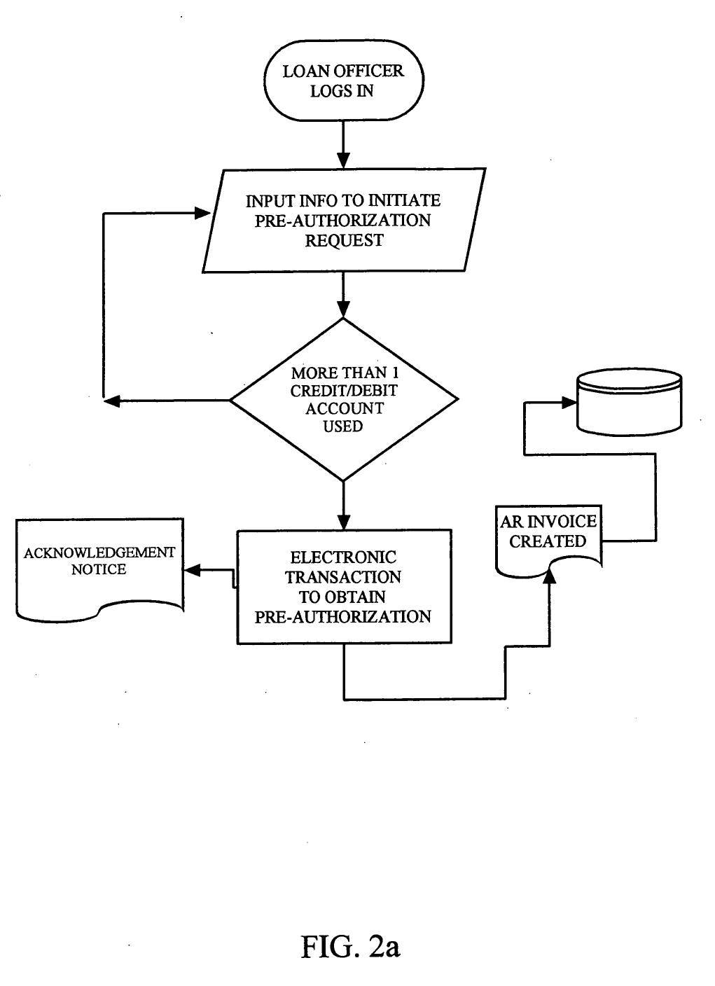

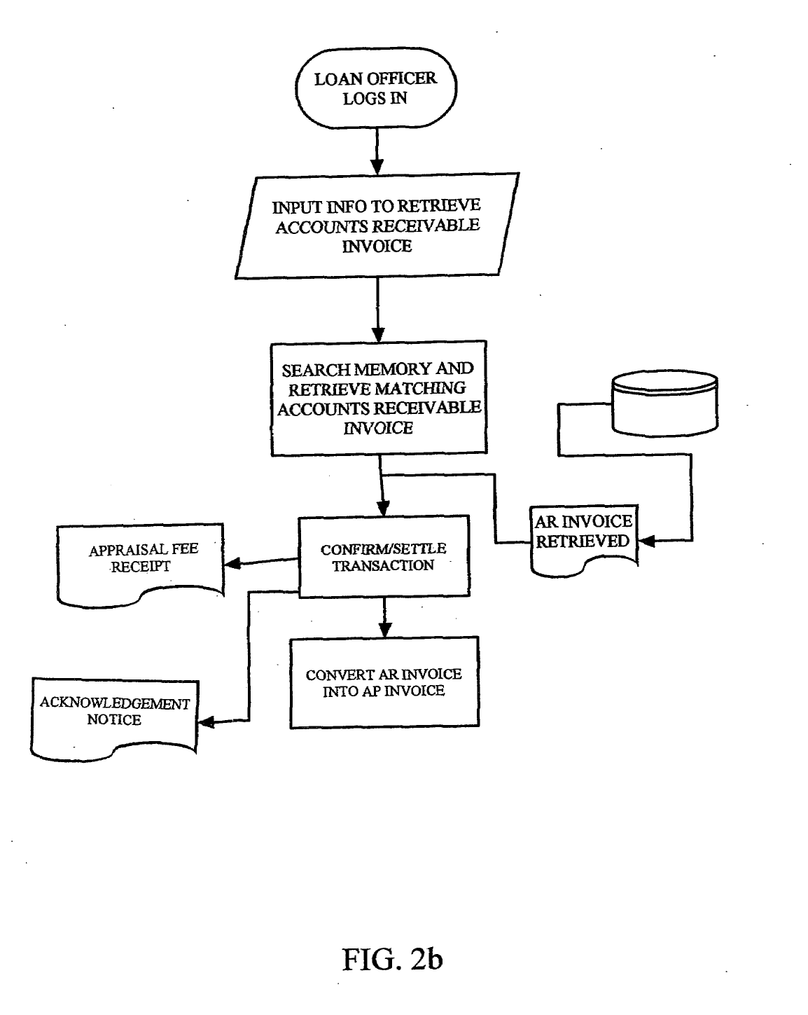

FIG. 2a illustrates a flowchart of the preferred operations for the software of the present invention when requesting and obtaining an appraisal fee pre-authorization. As shown in FIG. 2a, the Authorization Agent logs onto the server where the software program of the present invention resides (hosted) from a remote computer terminal via the Internet. As explained earlier, the software of the present invention is preferably hosted on a server located at a third party payor/payee location. Using credit card, debit card or checking account information provided/designated by the borrower, the Authorization Agent initiates a request to obtain a pre-authorization for payment of an appraisal fee for an appraisal to be conducted in a pending real estate transaction. The request preferably includes the last name of the borrower, the name of the Authorization Agent, the full name of the account holder, a tracking number, the credit/debit card and/or checking account information, the account number billing address (with zip code), the account holder's email address, the account holder's phone number and the amount of the pre-authorization requested. In a preferred embodiment, the amount of the pre-authorization requested is a pre-determined, set amount based upon various factors such as the size of the property (home) and its location.

In a preferred embodiment, the software of the present invention is designed to accommodate split tender for the appraisal fee payment if the borrower wishes to split the payment of the appraisal fee over two or more credit or debit cards or checking accounts. In such a case, the software allows the Authorization Agent to enter more than one account number per transaction (i.e. per pre-authorization request) and to further designate the amount of pre-authorization to be obtained from/charged to each individual account number. In this way, a single request to obtain a pre-authorization may have more than one actual pre-authorization tied to it.

Preferably, the software of the present invention is designed to adhere to account holder and data security and/or account holder communication requirements of NACHA (National Automated Clearing House Association) and the VISA/MASTERCARD associations. The VISA/MasterCard association requirements (also known as CIPS and PCI compliance) vary depending on transaction volume and it is anticipated that the software is designed to adhere to these requirements as the volume of transactions increases.

Once a request to obtain a pre-authorization for an appraisal fee has been initiated, the user software will initiate an electronic transaction and contact/communicate with the financial institution affiliated with the credit or debit account designated by the borrower in order to obtain the pre-authorization. Pre-authorization is obtained when the software makes a call to the payment processor. The payment processor communicates with the account issuer to obtain a result code and respond back to software. The software of the present invention will then wait until pre-authorization confirmation is received from the financial institution tied to/affiliated with the credit/debit card number used by the borrower.

When the software receives an approved result code, it performs two functions. First, an accounts receivable invoice is created using the information submitted by the Authorization Agent and retained for future settlement. Second, a notice is sent out via e-mail to the account holder informing him/her of the successful pre-authorization on his/her credit/debit card. The notice is called an Authorization Acknowledgement and reiterates the terms under which the account holder/borrower has agreed to allow for the pre-authorization. These terms preferably include when the card will be charged, who will be charging the card, charge considerations and cancellation policy.

Once a pre-authorization has been obtained, the loan officer/agent will retain an appraiser to conduct the appraisal and prepare a written appraisal report. The appraiser will appraise the subject property and prepare a complete appraisal report for the loan officer/agent. Once the report has been prepared/completed, it will be provided to the loan officer, along with an invoice for the total cost of the appraisal.

Once the real estate appraisal has been completed and the appraisal report provided to the loan officer/agent, a secondary agent (Settlement Agent) will log into the server and settle the appraisers invoice to the software. FIG. 2b illustrates a flowchart for the preferred operations of the software of the present invention in completing the appraisal fee transaction and ensuring payment of the fee to the appraiser. As shown in FIG. 2b, after the Settlement Agent logs onto/into the remote server where the software is resident and enters the transaction number and other identifying information so that the appropriate (matching) accounts receivable invoice can be located within the software and retrieved. Once the appropriate accounts receivable invoice has been properly identified and retrieved, the Settlement Agent enters settlement data from the appraiser's invoice into the software. The data includes amount/charge reflected in the appraiser's invoice, appraiser name, appraiser mailing address, appraiser phone number and an appraiser email address.

In the event the actual appraisal amount exceeds the pre-authorization by a predetermined dollar amount, then the software of the present invention is preferably configured to initiate a rejection/stop which advises the agent that a settlement cannot be completed for the requested amount. At this point the agent must either reduce the amount requested and/or initiate another pre-authorization. In this way the account holder is protected from incurring a charge which far exceeds the original pre-authorization amount.

Once the settlement data is entered, the Settlement Agent submits the data to the software. The software will again dial the payment processor to settle (charge) the pre-authorized account for the full settlement amount—i.e. the full amount/charge reflected in the appraiser invoice.

Once the transaction has been settled and the appraisal fee fully charged to the account holder's/borrower's account, the software of the present invention performs three functions. First, the account receivable invoice is converted into an accounts payable invoice which is stored for future processing. More specifically, the accounts payable invoice resides in memory until it is processed by the third party payor/payee and released in the form of a paper check payment or ACH payment to the appraiser. Second, the software generates and transmits a settlement acknowledgement notice, via e-mail, to the appraiser; informing him/her that the appraisal invoice has been settled to the software by the Settlement Agent and payment is scheduled to be remitted. This settlement acknowledgement notice further references the current accounts payable invoice pending payment and the payment terms. Finally, the software of the present invention generates and transmits to the account holder, via e-mail, an appraisal fee receipt notice, informing him/her that the account has been charged for the completion of the real estate appraisal. The appraisal fee receipt notice further references the date of the pre-authorization, the date of the actual settlement of the charge/appraisal fee, the account number charged, amount of the final charge, and a software tracking number along with instructions for obtaining a copies of the appraiser's invoice(s) that resulted in the current charge to the account holder's account.

The preceding information accurately describes the major features and functionality of the software application of the present invention. While the description above contains many specifics, it should not be construed as a limitation on the scope of the invention, but rather as an illustration of exemplifications of particular embodiments thereof. One of ordinary skill in the art may make many changes, modifications, and substitutions without necessarily departing from the spirit and scope of the invention.

What is claimed is:

1. A software program for completing an appraisal payment transaction on behalf of a borrower as part of an overall real estate transaction, wherein said software is configured to:
receive input requesting that a pre-authorization for an appraisal fee be obtained;
obtain a pre-authorization from a financial institution wherein said account is held;
generate a pre-authorization notice indicating that a pre-authorization in the amount of said appraisal fee has been obtained on the account owned or designated by said borrower, said pre-authorization notice then being transmitted to the account holder via e-mail;
create an accounts receivable invoice and store said invoice;
receive input acknowledging that an appraisal associated with said appraisal fee has been completed;
settle said pre-authorization;
retrieve said accounts receivable invoice and convert it into an accounts payable invoice; and
generate a settlement notice indicating that the appraisal has been completed and the account charged, said settlement notice then being transmitted to the account holder via e-mail.

2. The software program of claim 1, wherein the software is further configured to
generate an acknowlegement notice indicating that the appraiser's invoice has been settled to software and payment is pending; said acknowledgement then being transmitted to the appraiser via e-mail

3. The software program of claim 1, wherein the input requesting that a pre-authorization for an appraisal fee be obtained includes at least one credit/debit card or checking account number affiliated with an account owned or designated by said borrower to which said appraisal fee is to be charged

4. The software program of claim 3, wherein the input requesting that a pre-authorization for an appraisal fee be obtained includes a pre-authorization amount.

5. The software program of claim 4, wherein the input acknowledging that an appraisal associated with said appraisal fee has been completed includes a settlement/appraisal fee to be charged to the at least one credit/debit card or checking account.

6. The software program of claim 5, wherein the software is further configured to generate a rejection/stop in the event the settlement/appraisal fee exceeds the pre-authorization amount previously input.

7. A method for ensuring payment in an appraisal transaction on behalf of a borrower as part of an overall real estate transaction, wherein said method includes:
(a) communicating with a server on which proprietary software is located, said software designed to:
receive input requesting that a pre-authorization for an appraisal fee be obtained;
obtain a pre-authorization from a financial institution wherein said account is held;
generate a pre-authorization notice indicating that a pre-authorization in the amount of said appraisal fee has been obtained on the account owned or designated by said borrower, said pre-authorization notice then being transmitted to the account holder via e-mail;
create an accounts receivable invoice and store said invoice in the software;
receive input acknowledging that an appraisal associated with said appraisal fee has been completed;
settle said pre-authorization;
retrieve said accounts receivable invoice and convert it into an accounts payable invoice, said accounts payable invoice indicating the full amount of the appraisal fee to be paid and the name of the appraiser to whom said payment should be made;
generate a settlement notice indicating that the appraisal has been completed and the account charged, said settlement notice then being transmitted to the account holder via e-mail; and
generate acknowlegement notice indicating that the appraiser's invoice has been settled to software and payment is pending; said acknowledgement then being transmitted to the appraiser via e-mail
(b) receiving said accounts payable invoice and providing payment of the appraisal fee to the appraiser as set forth in said invoice.

8. The method of claim 7, wherein the input requesting that a pre-authorization for an appraisal fee be obtained includes at least one credit/debit card or checking account number affiliated with an account owned or designated by said borrower to which said appraisal fee is to be charged.

9. The method of claim 8, wherein the input requesting that a pre-authorization for an appraisal fee be obtained includes a pre-authorization amount.

10. The method of claim 9, wherein the input acknowledging that an appraisal associated with said appraisal fee has been completed includes a settlement/appraisal fee to be charged to the at least one credit/debit card or checking account.

11. The method of claim 10, wherein the software is further configured to generate a rejection/stop in the event the settlement/appraisal fee exceeds the pre-authorization amount previously input.
